(19) United States
(12) Patent Application Publication
(10) Pub. No.: US 2024/0084643 A1
(43) Pub. Date: Mar. 14, 2024

(54) ELECTRONIC WINDOW BLINDS

(71) Applicant: OLAYINKA ADEWUNMI ADEBIYI, BLOOMFIELD, NJ (US)

(72) Inventor: OLAYINKA ADEWUNMI ADEBIYI, BLOOMFIELD, NJ (US)

(21) Appl. No.: 18/512,970

(22) Filed: Nov. 17, 2023

Related U.S. Application Data
(63) Continuation of application No. 16/402,230, filed on May 3, 2019.

(51) Int. Cl. E06B 9/386

(52) U.S. Cl. CPC E06B 9/386

(57) ABSTRACT

A window blinds assembly that can include slats installed either horizontally or vertically forming a window blind. The slats include a one-way-see-through layer and are tinted, wherein the level of tint can be electronically manipulated. The opening and closing of the slats are electronically operated by a motor. A remote control can be used to communicate with the assembly. A display can also be includes for displaying messages.

### CROSS-REFERENCE TO RELATED APPLICATIONS

This application is a continuation of a U.S. patent application Ser. No. 16/402,230 filed on May 3, 2019, which is incorporated herein by reference in its entirety.

### FIELD OF INVENTION

The present invention relates to window blinds, and more particularly, the present invention relates to electronically operable window blinds.

### BACKGROUND

Windows are quite common in any building including residential and commercial. Windows are an essential element of any home decor that allows receiving light and air within a room. Moreover, the windows can set the tone for a room, creating a pleasant mood through bright, sunny light, and a direct view of the outdoors. Because windows let in vibrant sunshine, most people find it necessary to attach vertical window blinds inside their windows, to offer necessary shade. Additionally, window blinds are used to protect the homeowner's privacy, particularly in the evening hours when light shining from overhead lights and floor lamps illuminates through the window, offering passersby a free view into the home. Produced in a variety of sizes and colors, as well as a broad selection of materials such as aluminum, plastic, and wood, window blinds are a necessary item found in most households.

Although indeed a practical necessity, the use of window blinds is not without drawbacks. Many consumers find it frustrating that a set of window blinds can obstruct one's view of the outdoors. This problem is only made worse when the blinds are completely closed. Simply stated, to block the harsh sunlight from entering one's room, window blinds must be closed to completely encompass the surface of the window. As such, the homeowner is denied the pleasure of peering out their window to enjoy a carefully manicured lawn or even a rose garden during the daylight hours. In addition, adjusting the blinds to a preferred setting can be annoying and time-consuming for many. Manually operated, the window covers must be raised and lowered via a set of pull strings and opened and closed with an elongated, twisting rod. As many consumers would attest, it can be a bit frustrating to have to stop in the middle of cooking dinner or to leave the comforts of an easy chair to adjust and readjust blind settings as the sunlight levels change. The tools for operating window blinds also contain their own set of challenges. Connected to the unit by only a flimsy hook through a thin slot, the twist rod is used so often that it easily breaks, resulting in the expensive replacement of the blinds. The most devastating drawback associated with window blinds, however, is that the dangling pulls strings utilized to operate the blinds can be dangerous, presenting a hazard in homes with small children. In fact, according to the Consumer Products Safety Commission, every two weeks, a child loses their life due to strangulation caused by window blind cords.

Thus, a need is appreciated for window blinds that are more efficient, convenient, and safe.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to window blinds that are one-way see-through.

It is another object of the present invention that window blinds can block an inside view of a home from outside but an outside view from inside a home can be selectively blocked and unblocked.

It is still another object of the present invention that window blinds do not have hanging cords preventing the risk of tangling.

It is yet another object of the present invention that window blinds can shield harsh sunlight.

It is a further object of the present invention that window blinds can be remotely operated.

It is still a further object of the present invention that window blinds can display a message.

In one aspect, disclosed is a window blind assembly that can include slats installed either horizontally or vertically forming a window blind.

These and other objects and advantages of the embodiments herein and the summary will become readily apparent from the following detailed description taken in conjunction with the accompanying drawings.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 shows an exemplary embodiment of the window blinds assembly having a housing and slats installed horizontally, according to the present invention.

FIG. 2 shows another exemplary embodiment of the window blinds assembly in which the slats are arranged vertically, according to the present invention.

FIG. 3 is a block diagram of the window blinds assembly, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context indicates otherwise. It will be further understood that the terms “comprise”, “comprising,”, “includes” and/or “including” when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are window blinds that provide privacy and security plus the advantage of an unfettered view of the outdoors while preventing others from seeing inside. The window blinds are made from UV-resistant materials. The window blinds can be operated using a remote control.

The disclosed window blinds include a set of slats that can be manufactured of a tint and UV-resistant material. Moreover, the amount of tint can be adjusted. The window blinds can be operated via a handheld remote control, computer, and/or a smartphone. The window blinds can be connected to the handheld unit through Bluetooth® or Wi-Fi.

The disclosed window blinds can provide people with an easy and convenient means of opening and closing their blinds and adjusting the degree of tint on the surface of the blinds to facilitate optimal comfort and an unfettered view of the outdoors while preventing others from seeing inside.

Privacy is a vital component of safety in one's home and blinds provide privacy through the one-way see-through blinds, keeping out harsh sunlight but still allowing the user to see outdoors with the blinds closed. Just like one-way glass windows. Besides the privacy, there are no strings into which the kids or pets may get tangled in.

The remote control includes a receiver and transmitter for communicating with the blinds and can control the rate of movement of the window slats per second.

The window blind assembly can include an electric motor control panel consisting of a simple mechanism that drives the slats of the blinds back and forth, and up and down. The electric motor runs the drive that controls the movement of the window slats.

The slats can be made from plastic or lightweight plexiglass carefully designed to accommodate a one-way blocking tint film and materials, UV-Ray resistant materials, and tint materials.

The assembly allows controlling multiple window blinds for multiple windows. Each window blind can be uniquely identified by the assembly and an identifier, such as first, second, . . . can be given to each window blind. Such programming can be done at the time of installation to be individually identified by simply naming each blind, e.g. 1, 2, 3, . . . windows. This gives the user the freedom to choose which window blind to communicate with. Using the remote control, the disclosed blind assembly provides one-way see-through window blinds that fit perfectly on most windows and doors.

Window blinds according to the present invention can be made using lightweight strong plastic panels and lightweight plexiglass with one-way blocking materials and tint control materials.

The slat driver stabilizes the window slats' movement and controls the movement of the window slats, which opens and closes the window. This is part of the electric motor panel components.

The Electric motor controls the movement of the window slats in conjunction with the slat driver for the opening and closing of the window. This component is in the window panel, also referred to as a housing.

The assembly includes an active receiver and processors configured in a motherboard. Messages and instructions for controlling the window blinds can be sent by the assembly. Communication can be made using Bluetooth®, Wi-Fi, and the like wireless technologies.

The window panel is the operating unit of the window blinds, here resides all operating components, the movement mechanism, motherboard, and wires are stored, and the window slats are attached to it.

The motherboard is a mini-computer operating system unit capable of operating software and applications that handle the messages to the blinds and the tint control units. This unit resides in the window panel.

The remote-control device also has voice control capability. The remote-control device is used to operate the window blinds. The remote-control device has all the functionality and commands of the window blind. The remote-control device is fully equipped and operational.

The tint film is one of the materials that can be used to develop one-way see-through window slats. One-way-see-through windows are known, for example, and can be used in police interrogation rooms.

The electric dimmer switch is a component of the motherboard that controls the level of tint of the window blinds, the tint dimmer operates from lightest to darkest.

The Rechargeable backup battery can power the window blinds for at least 24 hours without the connection of a natural energy supply, it's a powerful Li-ion battery type 19000 mAh and can power the window blinds individually. Part of the components of the window panel.

Blind could be configured with either vertical or horizontal slats, with the slats themselves manufactured of a lightweight, UV-resistant plexiglass, glass, vinyl, plastic, or comparable, clear, tinted material. The tinted material in the blind slats can be configured so that the surface of the blinds would be see-thru when fully closed similarly as if peering through the tinted auto glass, yet the exterior of the blinds would obstruct the view of the interior of the room in which the blinds are installed in a similar effect to one-way glass. In this manner, the disclosed blinds would provide an unfettered view of the outdoors, even when the blinds are closed, thus protecting the user's privacy and personal security in the process. The tint offered in the disclosed blinds could include standard adjustable window tint or this see-through tint could be made available in a variety of colors to compliment various home decors. Importantly, this tint would be fully adjustable, with varying degrees of tint ranging from lightest to darkest, with this tint modified via remote control. This same remote would also serve to control the movement of the blinds. Unlike standard window treatments, disclosed Blinds do not contain the turning rod or pull string but are connected to an electronic motor that adjusts to the positioning of the blinds, on demand, by remote control. As such, the disclosed Blinds would feature an electronic receiver circuit along with a tuned frequency necessary for the remote operation of the window blinds.

The remote may be rectangular in shape and comparable in size to a standard television remote control device. On the front portion of the remote control can be an on/off switch, as well as directional buttons for use in raising, lowering opening, and closing the blinds. Operational settings would also be included for controlling the degree of tint of the individual blind slats. The remote control could be battery-powered or rechargeable.

A designated software application can enable the user to control the blinds through their smartphone, tablet, or computer. In addition, a computer chip in the window panel or motherboard will be capable of transmitting messages to be displayed on a window slate when it is closed. An incoming message notification can also be displayed on the windows state to signal the owner.

The disclosed assembly may be extremely convenient to use. The one-way see-through blind slats have a tint that can be adjusted by personal preference or lighting conditions. The disclosed blinds would enable consumers to block harsh sunlight from entering their homes, while still enjoying an unobstructed view out through the window on which the blinds are installed.

Consumers should appreciate that even if the blinds are completely closed, they can still look out their window to keep a close watch on their children playing in the yard or simply enjoy a cultivated landscape with a one-way view. Homeowners could look out through their windows while preventing strangers or passersby from peering into one's home. The disclosed assembly may offer consumers the ultimate combination of convenience, Privacy, and style for their homes.

The disclosed blinds could be configured with either vertical or horizontal slats, with the slats themselves manufactured of a lightweight Plexiglass, glass, vinyl, plastic, or comparable, clear, tinted material. The tinted material that comprises the blind slats can be configured so that the surface of the blinds would be see-thru when fully closed similarly as if peering through the tinted auto glass, yet the exterior of the blinds would obstruct the view of the interior of the room in which the blinds are installed, in a similar effect to one-way see-through glass. In this manner, the Blinds would provide an unfettered view of the outdoors, even when the blinds are closed, while also protecting the user's privacy and personal security in the process. The tint offered in the Blinds could include standard amber tint common to adjustable window tint, or this see-through tint could be made available in a variety of colors to compliment various home decors. Importantly this tint would be fully adjustable, with five degrees of tint ranging from one (being the lightest) to 5 (being the darkest) available, with this tint modified via electrical power.

The second main component of the disclosed Blinds assembly is found in their remote operations. Unlike standard window treatments, the disclosed Blinds would not contain the turning rod or pull strings common, rather, the disclosed window blinds would be connected to an electronic motor that adjusts the positioning of the blinds, on demand. As such, the Blinds would feature an electronic receiver circuit, along with a tuned frequency necessary for the remote operation of the window blinds. Serving as the transmitter for the Blinds, an independent remote-control device would be included for use with the blinds and would be rectangular in shape and comparable in size to a standard television remote control device. Located on the front panel of this remote would be a simple on/off switch, as well as directional buttons for use in raising, lowering opening, and closing the blinds. Operational settings would also be included for controlling the degree of tint that encompasses the surface of the individual blind slats. As with standard remote-control devices, the interior components of the remote control would be comprised of a frequency generator, amplifier, internal antenna, and the required electrical/electronic components and circuitry, all encased within the unit's durable plastic housing. The remote could be powered by a rechargeable battery source such as lithium, nickel-cadmium, or nickel-metal hydride, while the blinds themselves could feature a standard power cord, to be connected to a traditional power outlet and operating on conventional 110 volts, sixty hertz power.

The use of Blinds would be very simple and straightforward. First, the user would determine what size blinds are needed by carefully measuring each window area to be covered. Once the correct size has been ascertained, the user would then choose whether they wanted vertical or horizontal blinds, selecting Blinds in the desired tint. Blinds could be installed on virtually any window, as well as over sliding glass doors. To open the slats of the blinds, the user would simply point the remote control at the window and press the designated button, opening the blinds and infusing the room with light. The user could also adjust the positioning of the blind slat so that the Blinds were partially opened at the desired angle. To adjust the degree of the tint of the blinds, the user would simply select the remote control setting as desired, with the user selecting the option of one for a noticeably light tint and 5 for a dark tint. Whether opening the blinds or adjusting the tint of the blind slats, the remote unit would function in the same manner: the companion receiving unit, located in the blinds, would be tuned to a specific frequency generated by the transmitter unit. Upon reception of the signal generated by the transmitter, the circuitry in the receiver would generate an “enable” signal to the logic device (an “AND” integrated circuit chip or comparable), which would apply a voltage level to the unit, obeying the commands set forth by the button selection.

There are several significant benefits and advantages associated with this unique invention. Foremost, the Blinds would offer consumers attractive window coverings that are extremely convenient, easy, and safe to use. Featuring cleverly designed one-way, see-through blind slats, the tint of which can be adjusted by personal preference or lighting conditions.

Blinds would enable consumers to block harsh sunlight from entering their homes, while still enjoying an unobstructed view out through the window on which the blinds are installed. Consumers should appreciate that even if the blinds were completely closed, they could still look out their window to keep a close watch on children playing in the yard, or simply to enjoy a carefully cultivated landscape. With the adjustable tint that comprises the Blinds featuring a one-way view, homeowners could look out through their windows, while preventing strangers or passersby from peering into one's home. Protecting the user's privacy, the Blinds would enable homeowners to enjoy a measure of confidence and comfort within their homes, with the tint easily adjusted in accordance with the time of day or weather conditions.

Consumers should especially appreciate that the Blinds would be operated by remote control, allowing for adjustment of the blind's tint or the positioning of the blind's slats, from practically any vantage point in the room. In this manner, a consumer could open the blinds for morning light while enjoying breakfast in bed or lower the blinds to reduce glare on the TV screen while sitting on the couch. As the Blinds do not need a turning rod for opening and closing, this practical product would eliminate the costly hassle that broken rods entail. Most importantly, the absence of pull strings for raising and lowering the blinds would make Blinds ideal for homes with small children, as there are no dangling parts that could cause injury, or worse. An invaluable safety tool, the use of Blinds could effectively prevent the serious accidents, injuries, and even fatalities that occur every year as a result of dangling window blind cords. In this manner, the Blinds would prove ideal for a child's nursery, bedroom, or playroom, offering parents the peace of mind that their little one would be safe from injury and harm.

Easily installed with standard household tools, the Blinds would be well-suited for virtually any room in the house. Although designed specifically for household use, the Blinds could be utilized in any public or private building. Made of durable, high-quality materials and components, the Blinds should withstand years of continued use.

An innovative product invention, the Blinds would offer consumers the ultimate combination of convenience, privacy, and style for their homes. Featuring a sophisticated electronic transmitting and receiving system, this practical product would enable consumers to operate their blinds simply and safely. Affordably priced, general household consumers should well receive the Blinds, with a very sizable market potential.

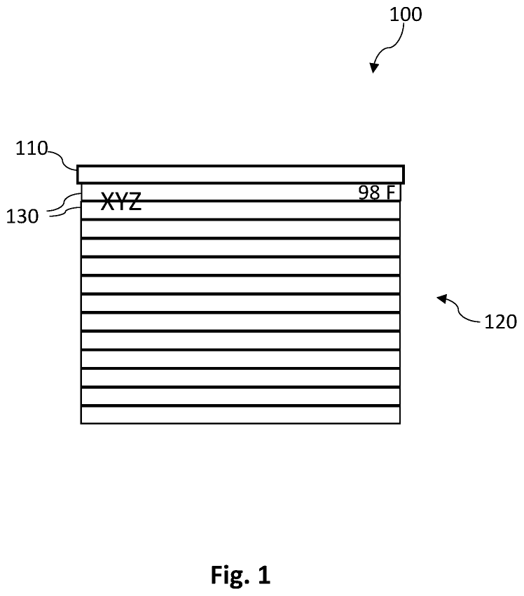

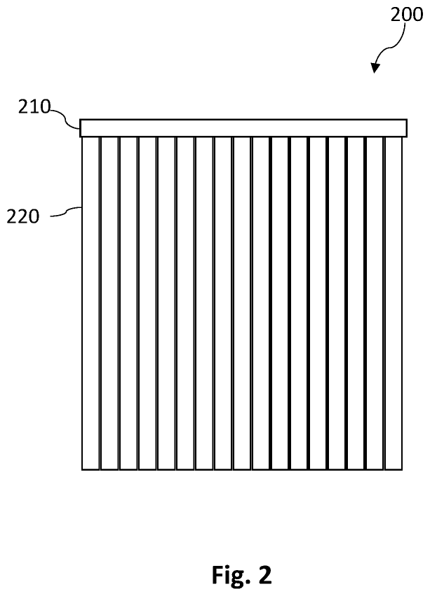

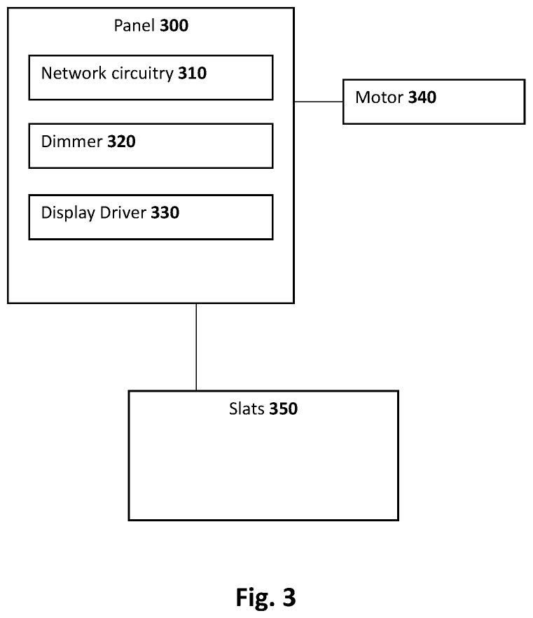

Referring to FIG. 1 which shows the window blinds assembly 100 that includes a housing 110, slats 120, and a display panel 130. FIG. 2 shows assembly 200 having a housing 210 and slats 220 are vertically aligned. FIG. 3 is a block diagram showing the panel 300 that encases a network circuitry 310, a dimmer 320, and a display driver 330. A motor 340 can control the slats 350.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A window blinds assembly comprising:
a housing;
a window blind suspended through the housing, the window blind comprising:
a plurality of slats arranged horizontally or vertically, and
each slat of the plurality of slats comprises a layer of one-way blocking materials and is tinted;
a tint control unit configured to control tint levels, wherein a tint dimmer operates to control the tint levels from lightest to darkest; and
an electric motor control panel comprising an electric motor for raising and lowering the plurality of slats back and forth, and up and down.

2. The window blinds assembly according to claim 1, wherein the tint levels are electrically controlled.

3. The window blinds assembly according to claim 1, wherein the window blinds assembly further comprises a display configured to display messages.

4. The window blinds assembly according to claim 1, wherein the window blinds assembly further comprises a network circuitry for connecting to an external computing device, wherein the window blinds assembly is configured to receive instructions through the external computing device.

5. The window blinds assembly according to claim 4, wherein the instructions are for raising or lowering the window blind.

6. The window blinds assembly according to claim 5, wherein the external computing device is a smartphone.

7. The window blinds assembly according to claim 1, wherein the window blind permits an outside view from inside but blocks an inside view from outside.

8. A method for covering a window, the method comprising the steps of:
providing a window blinds assembly comprising:
a housing;
a window blind suspended through the housing, the window blind comprising:
a plurality of slats arranged horizontally or vertically, and
each slat of the plurality of slats comprises a layer of one-way blocking materials and is tinted;
a tint control unit configured to control tint levels, wherein a tint dimmer operates to control the tint levels from lightest to darkest; and
an electric motor control panel comprising an electric motor for raising and lowering the plurality of slats back and forth, and up and down;
receiving an instruction; and
upon receiving instruction, changing the tint levels.

9. The method according to claim 8, wherein the tint levels are electrically controlled.

10. The method according to claim 8, wherein the window blinds assembly further comprises a display configured to display messages.

11. The method according to claim 8, wherein the window blinds assembly further comprises a network circuitry for connecting to an external computing device, wherein the window blinds assembly is configured to receive instructions through the external computing device.

12. The method according to claim 11, wherein the instructions are for raising or lowering the window blind.

13. The method according to claim 12, wherein the external computing device is a smartphone.

14. The method according to claim 8, wherein the window blind permits an outside view from inside but blocks an inside view from outside.
